(19) United States
(12) Patent Application Publication
(10) Pub. No.: US 2016/0070437 A1
(43) Pub. Date: Mar. 10, 2016

(54) ELECTRONIC DEVICE AND METHOD FOR DISPLAYING DESKTOP ICONS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); HAI-JUN MAO, Shenzhen (CN); HAI-SEN LIANG, Shenzhen (CN)

(21) Appl. No.: 14/713,344

(22) Filed: May 15, 2015

(30) Foreign Application Priority Data
Sep. 5, 2014 (CN) 201410450517.0

(51) Int. Cl. G06F 3/0481

(52) U.S. Cl. CPC G06F 3/04817; G06F 3/04815

(57) ABSTRACT

A method for displaying desktop icons in an electronic device at first shows all icons as having a three-dimensional appearance and a default depth. A frequency of execution is recorded for each executed application having an icon and the apparent depth of each icon is changed to reflect different execution frequencies within a predetermined time period.

### CROSS-REFERENCE TO RELATED APPLICATIONS

This application claims priority to Chinese Patent Application No. 201410450517.0 filed on Sep. 5, 2014, the contents of which are incorporated by reference herein.

### FIELD

The subject matter herein generally relates to user interface management, and particularly to an electronic device and a method for displaying desktop icons.

### BACKGROUND

Many applications can be installed on an electronic device to expand the functions of the electronic device, and two-dimensional desktop icons corresponding to applications can be displayed on the desktop of the electronic device. User can finds a target icon inconveniently among multiple icons.

### BRIEF DESCRIPTION OF THE DRAWINGS

Implementations of the present disclosure will now be described, by way of example only, with reference to the attached figures.

FIG. 1 is a block diagram of one example embodiment of an electronic device including a desktop icons displaying system.

FIG. 2 is a diagrammatic view of one example embodiment of multiple desktop icons displayed in the electronic device of FIG. 1.

FIG. 3 is a flowchart of one example embodiment of a method for displaying desktop icons in the electronic device of FIG. 1.

FIG. 4 is a flowchart of one example embodiment of a method for changing apparent depths of desktop icons displayed in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “comprising” means “including, but not necessarily limited to”; it specifically indicates open-ended inclusion or membership in a so-described combination, group, series and the like. The term “module” refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

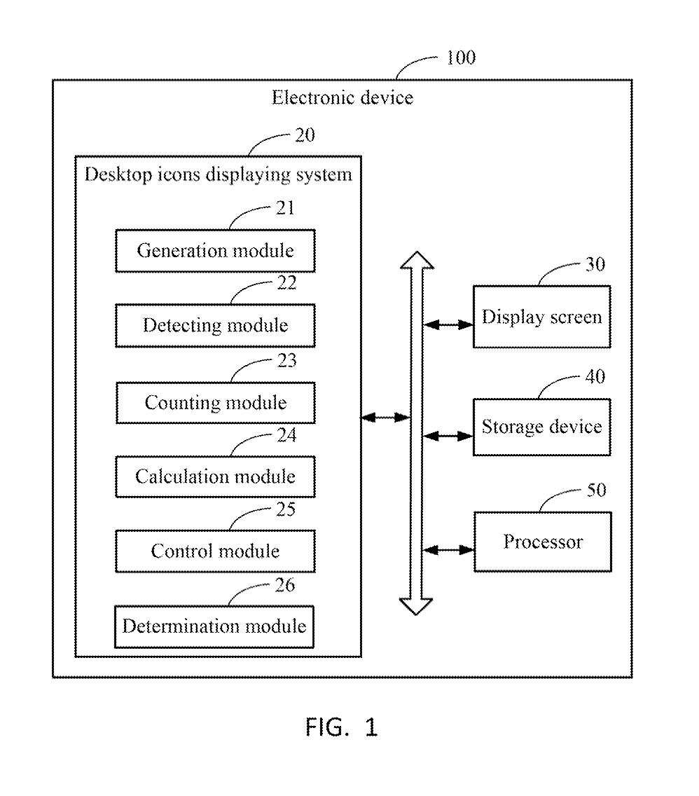

FIG. 1 is a block diagram of an example embodiment of an electronic device. In at least one embodiment as shown in FIG. 1, an electronic device 100 includes, but is not limited to, a desktop icons displaying system 20, a display screen 30, a storage device 40, and at least one processor 50. The desktop icons displaying system 20 is coupled to the display screen 30, the storage device 40, and the at least one processor 50. FIG. 1 illustrates only one example of the electronic device 100, other examples can comprise more or fewer components than illustrated, or have a different configuration of the various components.

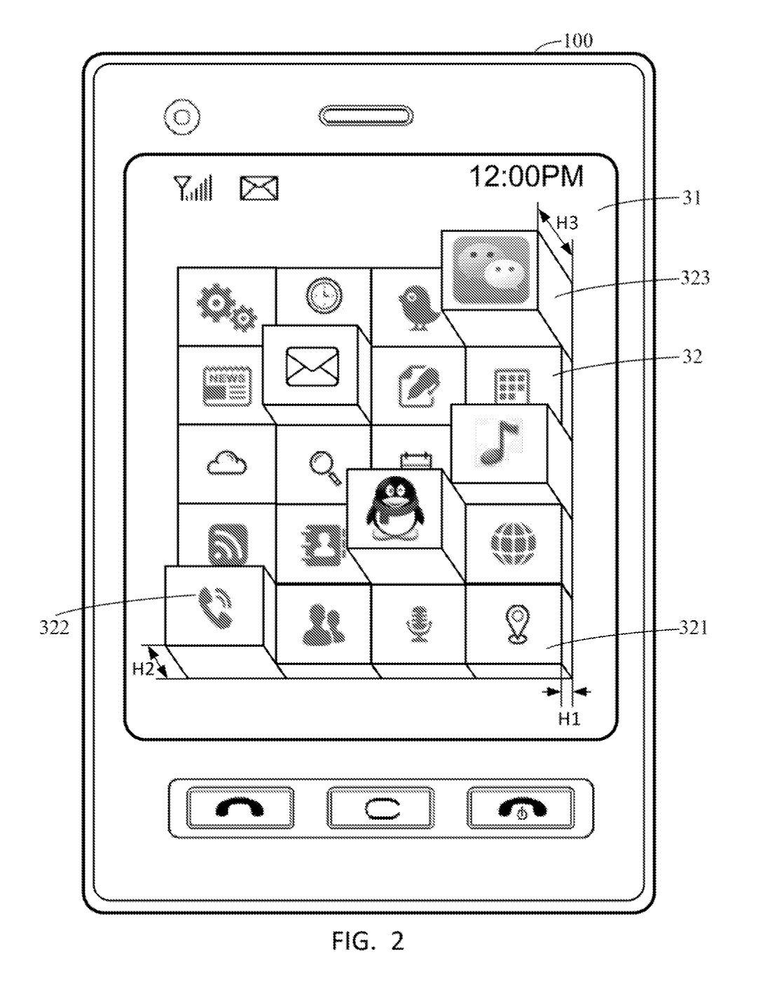

In one embodiment, the electronic device 100 can be mobile phones, personal computer, tablet computer, or any other suitable electronic device. The display screen 30 can display a desktop 31 (as shown in FIG. 2) of the electronic device 100.

The storage device 40 can be an internal storage device, such as a flash memory, a random access memory (RAM) for temporary storage of information, and/or a read-only memory (ROM) for permanent storage of information. The storage device 40 can also be an external storage device, such as an external hard disk, a storage card, or a data storage medium. The at least one processor 50 can be a central processing unit (CPU), a microprocessor, or other data processor chip that performs functions of the electronic device 100.

In one embodiment, the desktop icons displaying system 20 can generate a number of desktop icons 32 (as shown in FIG. 2) each of which corresponds to an application of the electronic device 100, show all icons as having a three-dimensional appearance and a default depth, record an execution frequency of each executed application within a predetermined time period, and change the apparent depth of each icon 32 in the display screen 30 according to the execution frequencies of the applications, to reflect different execution frequencies of each application within a predetermined time period.

In at least one embodiment, the desktop icons displaying system 20 can include a generation module 21, a detecting module 22, a counting module 23, a calculation module 24, a control module 25, and a determination module 26. Modules 21-26 can comprise computerized instructions in the form of one or more computer-readable programs that can be stored in a non-transitory computer-readable medium, for example in the storage device 40, and are executed by the at least one processor 50 of the electronic device 100 to provide functions of the present disclosure. A detailed description of the functions of the modules 21-26 is given below in reference to FIG. 1.

The generation module 21 generates a number of desktop icons 32, each of the icons 32 corresponds to an application of the electronic device 100. Each icon 32 has a three-dimensional appearance and a default depth. The control module 25 renders each of the icons 32 as having the three-dimensional appearance and the default depth on the display screen 30.

The detecting module 22 detects that at least one of the applications is executed within a predetermined time period, such as a week, or a month, and the counting module 23 records an execution frequency of each executed application and a total execution frequency of all of the applications within the predetermined time period, and stores the execution frequency of each application and the total execution frequency of all of the applications in the storage device 40.

The calculation module 24 calculates a ratio of the execution frequency of each application relative to the total execution frequency of all of the applications.

In at least one embodiment, if the execution frequencies of the applications are different, the calculated ratios will each be different. In at least one embodiment, if a specific application is executed more frequently within the predetermined time period, the ratio of the execution frequency of the specific application relative to the total execution frequency of all of the applications will be greater.

The control module 25 can change the apparent depth of each icon 32 on the display screen 30 according to each corresponding calculated ratio.

In at least one embodiment, the determination module 26 determines whether the calculated ratio of the execution frequency of a specific application relative to the total execution frequency of all of the applications increases or not. As shown in FIG. 2, if the determination module 26 determines that the calculated ratio of the execution frequency of the specific application relative to the total execution frequency of all of the applications increases, the control module 25 increases the apparent depth of the icon 32 of the specific application. Conversely, if the determination module 26 determines that the calculated ratio of the execution frequency of the specific application relative to the total execution frequency of all of the applications decreases, the control module 25 reduces the apparent depth of the icon 32 of the specific application.

In at least one embodiment, the storage device 40 stores a first predetermined depth H1, a second predetermined depth H2, a third predetermined depth H3, a first preset value, and a second preset value. The second predetermined depth H2 is greater than the first predetermined depth H1 but less than the third predetermined depth H3, that is H1<H2<H3. The first preset value is less than the second preset value.

In at least one embodiment, if the determination module 26 determines that the calculated ratio of the execution frequency of the specific application relative to the total execution frequency of all of the applications is less than a first preset value, the control module 25 changes the apparent depth of the icon, such as the icon 321, of the specific application to the first predetermined depth H1.

If the determination module 26 determines that the calculated ratio of the execution frequency of the specific application relative to the total execution frequency of all of the applications is not less than the first preset value but less than a second preset value, the control module 25 changes the apparent depth of the icon, such as the icon 322, of the specific application to the second predetermined depth H2.

If the determination module 26 determines that the calculated ratio of the execution frequency of the specific application relative to the total execution frequency of all of the applications is not less than the second preset value, the control module 25 changes the apparent depth of the icon, such as the icon 323, of the specific application to the third predetermined depth H3.

Therefore, if a specific application is executed more frequently within the predetermined time period, the icon of the specific application has a greater depth when displayed, which can help user to more quickly find an icon of a target application which is executed more frequently among all of the icons.

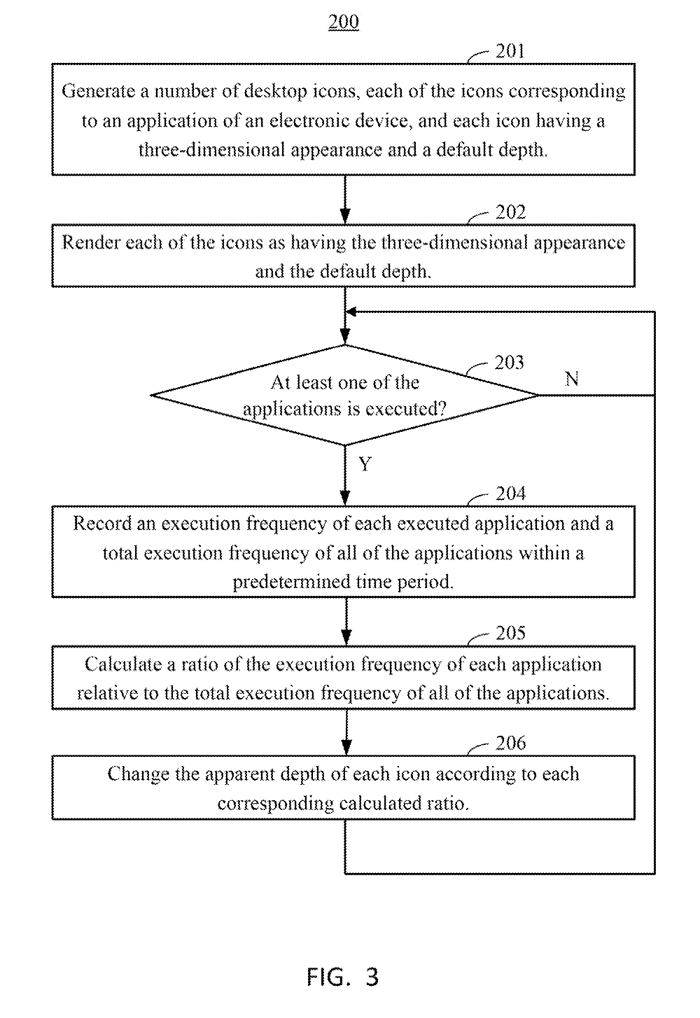

FIG. 3 illustrates a flowchart of an example embodiment of a method for displaying desktop icons in an electronic device. In an example embodiment, the method 200 is performed by execution of computer-readable software program codes or instructions by at least one processor of the electronic device.

Referring to FIG. 3, the flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining method 200. Each block shown in FIG. 3 represents one or more processes, methods, or subroutines, carried out in the exemplary method 200. Furthermore, the illustrated order of blocks is by example only and the order of the blocks can change. Additional blocks can be added or fewer blocks can be utilized without departing from this disclosure. The example method 200 can begin at block 201.

At block 201, a generation module generates a number of icons, each of the icons corresponds to an application of the electronic device, and each icon has a three-dimensional appearance and a default depth.

At block 202, a control module renders each of the icons as having the three-dimensional appearance and the default depth on a display screen of the electronic device.

At block 203, a detecting module detects whether at least one of the applications is executed within a predetermined time period, such as a week, or a month. If at least one of the applications is executed within a predetermined time period, block 204 is implemented. Otherwise the process remains in block 203.

At block 204, a counting module records an execution frequency of each executed application and a total execution frequency of all of the applications within the predetermined time period, and stores the execution frequency of each application and the total execution frequency of all of the applications in a storage device of the electronic device.

At block 205, a calculation module calculates a ratio of the execution frequency of each application relative to the total execution frequency of all of the applications.

In at least one embodiment, if the execution frequencies of the applications are different, the calculated ratios will each be different. In at least one embodiment, if a specific application is executed more frequently within the predetermined time period, the ratio of the execution frequency of the specific application relative to the total execution frequency of all of the applications will be greater.

At block 206, the control module changes the apparent depth of each icon on the display screen according to each corresponding calculated ratio.

In at least one embodiment, a determination module determines whether the calculated ratio of the execution frequency of a specific application relative to the total execution frequency of all of the applications increases or not. If the determination module determines that the calculated ratio of the execution frequency of the specific application relative to the total execution frequency of all of the applications increases, the control module increases the apparent depth of the icon of the specific application. Conversely, if the determination module determines that the calculated ratio of the execution frequency of the specific application relative to the total execution frequency of all of the applications decreases, the control module reduces the apparent depth of the icon of the specific application.

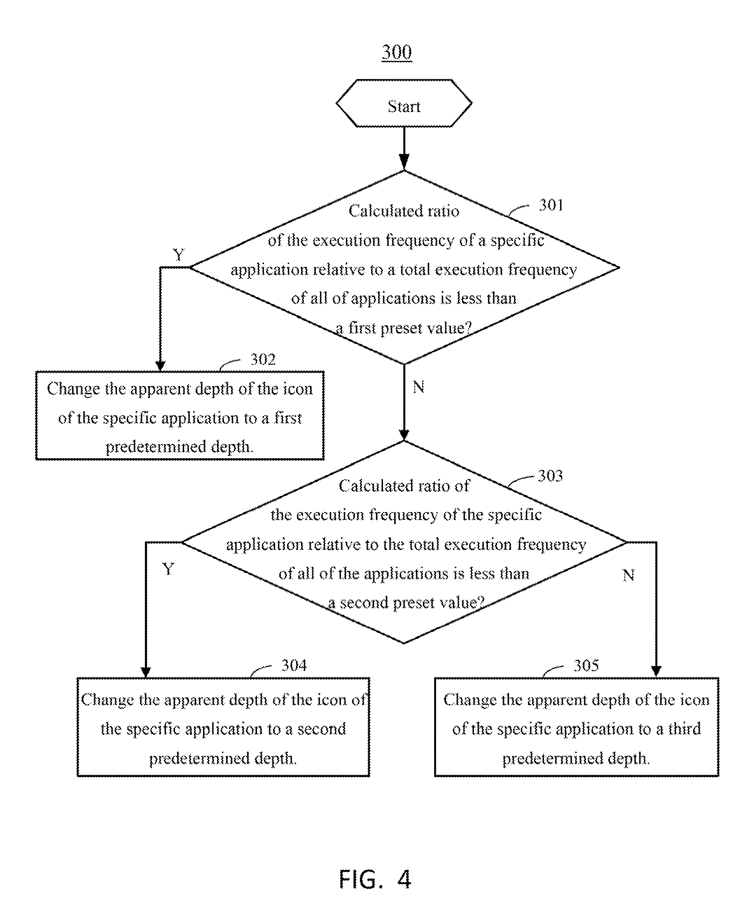

FIG. 4 illustrates a flowchart of an example embodiment of a method for changing the apparent depths of the desktop icons of the applications according to the calculated ratios. In an example embodiment, the method 300 is performed by execution of computer-readable software program codes or instructions by at least one processor of the electronic device. The example method 300 is provided by way of example, as there are a variety of ways to carry out the method. The method 300 described below can be carried out using the configurations illustrated in FIG. 1, for example, and various elements of these figures are referenced in explaining method 300. Each block shown in FIG. 4 represents one or more processes, methods, or subroutines, carried out in the exemplary method 300. Furthermore, the illustrated order of blocks is by example only and the order of the blocks can change. Additional blocks can be added or fewer blocks can be utilized without departing from this disclosure. The example method 300 can begin at block 301.

At block 301, the determination module determines whether the calculated ratio of the execution frequency of the specific application relative to the total execution frequency of all of the applications is less than a first preset value. If the determination module determines that the calculated ratio of the execution frequency of the specific application relative to the total execution frequency of all of the applications is less than a first preset value, block 302 is implemented. Otherwise, block 303 is implemented.

At block 302, the control module changes the apparent depth of the icon of the specific application to a first predetermined depth.

At block 303, the determination module determines whether the calculated ratio of the execution frequency of the specific application relative to the total execution frequency of all of the applications is less than a second preset value. If the determination module determines that the calculated ratio of the execution frequency of the specific application relative to the total execution frequency of all of the applications is less than a second preset value, block 304 is implemented. Otherwise, block 305 is implemented.

At block 304, the control module changes the apparent depth of the icon of the specific application to a second predetermined depth.

At block 305, the control module changes the apparent depth of the icon of the specific application to a third predetermined depth.

In at least one embodiment, the second predetermined depth is greater than the first predetermined depth but less than the third predetermined depth, and the first preset value is less than the second preset value.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. An electronic device comprising:
a display screen;
at least one processor coupled to the display screen; and
a non-transitory storage device coupled to the processor, the storage device storing one or more programs, which upon execution by the at least one processor, cause the at least one processor to:
generate a plurality of desktop icons, each of the icons corresponding to an application of the electronic device, each icon having a three-dimensional appearance and a default depth;
render each of the icons as having the three-dimensional appearance and the default depth on the display screen;
detect that at least one of the applications is executed within a predetermined time period;
upon such detection, record an execution frequency of each executed application and a total execution frequency of all of the applications within the predetermined time period;
calculate a ratio of the execution frequency of each application relative to the total execution frequency of all of the applications;
change the apparent depth of each icon on the display screen according to each corresponding calculated ratio.

2. The electronic device as described in claim 1, wherein the at least one processor increases the apparent depth of the icon of a specific application if the calculated ratio of the execution frequency of the specific application relative to the total execution frequency of all of the applications increases, and reduces the apparent depth of the icon of a specific application if the calculated ratio of the execution frequency of the specific application relative to the total execution frequency of all of the applications decreases.

3. The electronic device as described in claim 2, wherein the at least one processor changes the apparent depth of the icon of a specific application to a first predetermined depth if the calculated ratio of the execution frequency of the specific application relative to the total execution frequency of all of the applications is less than a first preset value, changes the apparent depth of the icon of a specific application to a second predetermined depth if the calculated ratio of the execution frequency of the specific application relative to the total execution frequency of all of the applications is not less than the first preset value but less than a second preset value, and changes the apparent depth of the icon of a specific application to a third predetermined depth if the calculated ratio of the execution frequency of the specific application relative to the total execution frequency of all of the applications is not less than the second preset value, wherein the second predetermined depth is greater than the first predetermined depth but less than the third predetermined depth, and the first preset value is less than the second preset value.

4. A computer-implemented method for displaying desktop icons in an electronic device being executed by a processor of the electronic device, the method comprising:
generating a plurality of desktop icons, each of the icons corresponding to an application of the electronic device, each icon having a three-dimensional appearance and a default depth;
rendering each of the icons as having the three-dimensional appearance and the default depth on a display screen of the electronic device;
detecting that at least one of the applications is executed within a predetermined time period;
upon such detection, recording an execution frequency of each executed application and a total execution frequency of all of the applications within the predetermined time period;
calculating a ratio of the execution frequency of each application relative to the total execution frequency of all of the applications;
changing the apparent depth of each icon on the display screen according to each corresponding calculated ratio.

5. The method as described in claim 4, wherein changing the apparent depth of each icon on the display screen according to each corresponding calculated ratio comprising:
determining whether the calculated ratio of the execution frequency of a specific application relative to the total execution frequency of all of the applications increases or not;
upon determining that the calculated ratio of the execution frequency of the specific application relative to the total execution frequency of all of the applications increases, increasing the apparent depth of the icon of the specific application; and
upon determining that the calculated ratio of the execution frequency of the specific application relative to the total execution frequency of all of the applications decreases, reducing the apparent depth of the icon of the specific application.

6. The method as described in claim 5, wherein changing the apparent depth of each icon on the display screen according to each corresponding calculated ratio further comprising:
determining that the calculated ratio of the execution frequency of the specific application relative to the total execution frequency of all of the applications is less than a first preset value;
upon such determination, changing the apparent depth of the icon of the specific application to a first predetermined depth;
determining that the calculated ratio of the execution frequency of the specific application relative to the total execution frequency of all of the applications is not less than the first preset value but is less than a second preset value;
upon such determination, changes the apparent depth of the icon of the specific application to a second predetermined depth; and
determining that the calculated ratio of the execution frequency of the specific application relative to the total execution frequency of all of the applications is not less than the second preset value;
upon such determination, changes the apparent depth of the icon of the specific application to a third predetermined depth;
wherein the second predetermined depth is greater than the first predetermined depth but less than the third predetermined depth, and the first preset value is less than the second preset value.

7. A non-transitory storage medium having stored thereon instructions that, when executed by at least one processor of an electronic device, causing the at least one processor to perform a method for displaying desktop icons in the electronic device, the method comprising:
generating a plurality of desktop icons, each of the icons corresponding to an application of the electronic device, each icon having a three-dimensional appearance and a default depth;
redering each of the icons as having the three-dimensional appearance and the default depth on a display screen of the electronic device;
detecting that at least one of the applications is executed within a predetermined time period;
upon such detection, recording an execution frequency of each executed application and a total execution frequency of all of the applications within the predetermined time period;
calculating a ratio of the execution frequency of each application relative to the total execution frequency of all of the applications;
changing the apparent depth of each icon on the display screen according to each corresponding calculated ratio.

8. The non-transitory storage medium as described in claim 7, wherein changing the apparent depth of each icon on the display screen according to each corresponding calculated ratio comprising:
determining whether the calculated ratio of the execution frequency of a specific application relative to the total execution frequency of all of the applications increases or not;
upon determining that the calculated ratio of the execution frequency of the specific application relative to the total execution frequency of all of the applications increases, increasing the apparent depth of the icon of the specific application; and
upon determining that the calculated ratio of the execution frequency of the specific application relative to the total execution frequency of all of the applications decreases, reducing the apparent depth of the icon of the specific application.

9. The non-transitory storage medium as described in claim 8, wherein changing the apparent depth of each icon on the display screen according to each corresponding calculated ratio further comprising:
determining that the calculated ratio of the execution frequency of the specific application relative to the total execution frequency of all of the applications is less than a first preset value;
upon such determination, changing the apparent depth of the icon of the specific application to a first predetermined depth;
determining that the calculated ratio of the execution frequency of the specific application relative to the total execution frequency of all of the applications is not less than the first preset value but is less than a second preset value;
upon such determination, changing the apparent depth of the icon of the specific application to a second predetermined depth; and
determining that the calculated ratio of the execution frequency of the specific application relative to the total execution frequency of all of the applications is not less than the second preset value;
upon such determination, changing the apparent depth of the icon of the specific application to a third predetermined depth;
wherein the second predetermined depth is greater than the first predetermined depth and is less than the third predetermined depth, and the first preset value is less than the second preset value.
